(19) United States
(12) Patent Application Publication
(10) Pub. No.: US 2018/0246641 A1
(43) Pub. Date: Aug. 30, 2018

(54) TRIGGERING CONTROL OF A ZONE USING A ZONE IMAGE OVERLAY ON AN IN-VEHICLE DISPLAY

(71) Applicant: GM Global Technology Operations LLC, Detroit, MI (US)

(72) Inventors: Yi G. Glaser, West Bloomfield, MI (US); Allan K. Lewis, Windsor (CA); Daniel S. Glaser, West Bloomfield, MI (US); Mohammad Naserian, Windsor (CA); Paul E. Krajewski, Troy, MI (US)

(21) Appl. No.: 15/445,048

(22) Filed: Feb. 28, 2017

(51) Int. Cl. G06F 3/0488; G06F 3/0482; G06F 3/0484; B60R 1/00; B60K 37/06

(52) U.S. Cl. CPC G06F 3/04886; G06F 3/0482; G06F 3/04847; B60R 1/003; B60K 2350/35; B60R 2300/105; B60R 2300/802; B60R 2300/8006; B60R 2300/207; B60K 37/06

(57) ABSTRACT

Examples of techniques for triggering control of a zone of a vehicle using a zone image overlay on an in-vehicle display are disclosed. In one example implementation, a method may include: displaying a primary image on the in-vehicle display; overlaying a zone image as the zone image overlay onto the primary image on the in-vehicle display, wherein the zone image overlay is associated with the zone of the vehicle; receiving a selection of the zone image overlay; responsive to receiving the selected zone image overlay, displaying a control interface on the in-vehicle display, wherein the control interface comprises a selectable option for controlling an aspect of the zone; and responsive to receiving a selection of the selectable option for controlling the aspect of the zone, adjusting the aspect of the zone based on the selection.

### INTRODUCTION

The present disclosure relates to triggering control of a zone using a zone image overlay on an in-vehicle display.

A vehicle, such a car, motorcycle, a boat, or any other type of automobile may be equipped with an in-vehicle display (e.g., a touchscreen). The display may be used to display camera images and other images to a driver of the vehicle. For example, a traditional rear-view mirror may be replaced with a display that displays a camera image from a camera positioned at the rear of the vehicle to display the “rear view” to the driver.

### SUMMARY

In one exemplary embodiment, a computer-implemented method for triggering control of a zone of a vehicle using a zone image overlay on an in-vehicle display includes displaying, by a processing device, a primary image on the in-vehicle display. The method further includes overlaying, by the processing device, a zone image as the zone image overlay onto the primary image on the in-vehicle display, wherein the zone image overlay is associated with the zone of the vehicle. The method further includes receiving, by the processing device, a selection of the zone image overlay. The method further includes responsive to receiving the selected zone image overlay, displaying, by the processing device, a control interface on the in-vehicle display, wherein the control interface comprises a selectable option for controlling an aspect of the zone. The method further includes responsive to receiving a selection of the selectable option for controlling the aspect of the zone, adjusting, by the processing device, the aspect of the zone based on the selection.

An example method may further include overlaying, by the processing device, additional zone images as additional zone image overlays onto the primary image on the in-vehicle display. In some example methods, each of the additional zone image overlays is associated with one of a plurality of additional zones of the vehicle. An example method may include hiding, by the processing device, the zone image overlay when the vehicle is in a drive mode. In some example methods, the zone is a passenger zone. The selectable option is selected from the group consisting of a temperature control, a light control, a seat adjustment, a window control, a video control, and an audio control. An example method may include, subsequent to adjusting the aspect of the zone, displaying, by the processing device, the primary image on the in-vehicle display.

In another exemplary embodiment a system for controlling a plurality of zones in a vehicle, the system comprising, the system includes a display configured to display a primary image. The system may further include a zone image overlay module configured to overlay a plurality of zone images as a plurality of zone image overlays onto the primary image on the display, wherein each of the plurality of zone image overlays is associated with one of a plurality of zones of the vehicle. The system may further include a control module configured to present a selectable option for controlling an aspect of one of the plurality of zones and to adjust the aspect of the one of the plurality of zones.

Some example systems further include a camera in each of the plurality of zones to capture the zone image for each of the plurality of zones. Some example systems further include camera external to the vehicle to capture the primary image. In some example systems, the zone image overlay module is further configured to hide the plurality of zone image overlays when the vehicle is in a drive mode. In some example systems, the selectable option is selected from the group consisting of a temperature control, a light control, a seat adjustment, a window control, a video control, and an audio control. In some example systems, the plurality of zones comprises at least one of a passenger zone, a trailer zone, and a cargo zone.

In yet another exemplary embodiment a computer program product for triggering control of a zone using a zone image overlay on an in-vehicle display may include a computer readable storage medium having program instructions embodied therewith, wherein the computer readable storage medium is not a transitory signal per se, the program instructions executable by a processing device to cause the processing device to perform a method. In examples, the method includes displaying, by a processing device, a primary image on the in-vehicle display. The method further includes overlaying, by the processing device, a zone image as the zone image overlay onto the primary image on the in-vehicle display, wherein the zone image overlay is associated with the zone of the vehicle. The method further includes receiving, by the processing device, a selection of the zone image overlay. The method further includes, responsive to receiving the selected zone image, displaying, by the processing device, a control interface on the in-vehicle display, wherein the control interface comprises a selectable option for controlling an aspect of the zone. The method further includes responsive to receiving a selection of the selectable option for controlling the aspect of the zone, adjusting, by the processing device, the aspect of the zone based on the selection.

An example method may further include overlaying, by the processing device, additional zone images as additional zone image overlays onto the primary image on the in-vehicle display. In some example methods, each of the additional zone image overlays is associated with one of a plurality of additional zones of the vehicle. An example method may include hiding, by the processing device, the zone image overlay when the vehicle is in a drive mode. In some example methods, the zone is a passenger zone. The selectable option is selected from the group consisting of a temperature control, a light control, a seat adjustment, a window control, a video control, and an audio control. An example method may include, subsequent to adjusting the aspect of the zone, displaying, by the processing device, the primary image on the in-vehicle display.

The above features and advantages, and other features and advantages, of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 illustrates a vehicle including a processing system for triggering control of a zone by touching a zone image overlay on an in-vehicle display according to embodiments of the present disclosure;

FIG. 2 illustrates a block diagram of the processing system of FIG. 1 that includes a zone image overlay module, a control module, and a display according to embodiments of the present disclosure;

FIG. 3 illustrates an example of a full display mirror that includes a display for displaying a primary image and a plurality of zone image overlays according to embodiments of the present disclosure;

FIG. 4 illustrates a flow diagram of a method for triggering control of a zone using a zone image overlay on an in-vehicle display according to aspects of the present disclosure; and

FIG. 5 illustrates a block diagram of a processing system for implementing the techniques described herein according to an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The technical solutions described herein provide for triggering control of a zone of a vehicle using a zone image overlay on an in-vehicle display. For example, a vehicle may be equipped with an in-vehicle display (e.g., a touchscreen), which may be used to display camera images and other images to a driver of the vehicle. As described above, a traditional rear-view mirror may be replaced with a display that displays a camera image from a camera positioned at the rear of the vehicle to display the “rear view” to the driver. Of course, the display may be used to display any suitable information, such as other views from or within the vehicle, navigational information, audio information, vehicle information, and the like.

The present techniques provide for overlaying zone images on the camera image of the in-vehicle display to enable a user (e.g., a driver, a passenger, etc.) to trigger control of a zone by touching one of the overlaid zone images. A zone may be, for example, a passenger zone, a cargo zone, a trailer zone, or some other zone of or related to the vehicle. A camera may capture images of a particular zone and then overlay the zone image on the in-vehicle display. The user may select one of the overlaid zone images to trigger control of the zone.

Accordingly, in one embodiment, the technical solutions described herein provide for a touch triggering an intuitive human machine interface (HMI) or other controls of a zone in an intuitive manner that reduces driver distraction and improves a user experience. For example, touching a rear seat zone image overlay provides an HMI to trigger a volume or temperature control of the rear seat zone. The HMI controls can be visually or auditory. Further utilization of interior and exterior cameras and display technology is also possible.

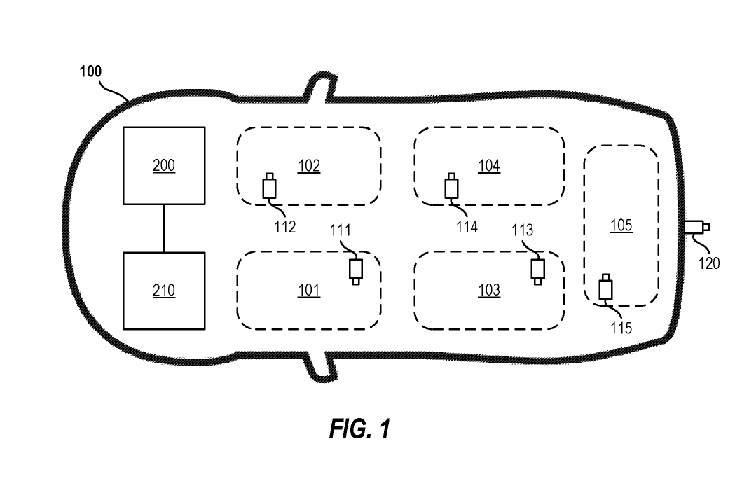

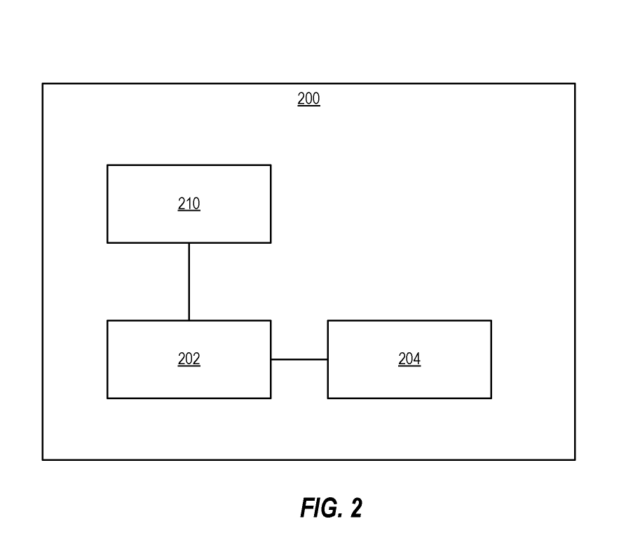

FIG. 1 illustrates a vehicle 100 including a processing system 200 for triggering control of a zone by touching a zone image overlay on an in-vehicle display 210 according to embodiments of the present disclosure. In particular, the vehicle 100 may include the processing system 200 and the display 210, which are described in more detail herein with reference to FIG. 2. The vehicle 100 may be a car, truck, van, bus, motorcycle, boat, plane, or another suitable vehicle 100.

The vehicle 100 may include a camera 120 that captures images external to the vehicle 100. The captured images (also referred to as a “primary image”) may be displayed on the display 210 to provide external views of the vehicle 100 to the driver of the vehicle 100. For example, the display 210 may be a full display mirror (FDM) which is enabled to display images, such as the primary image, from the camera 120. The FDM may be a traditional mirror in one mode or may be a display 210 for displaying digital images in another mode. It should be appreciated that camera images may be displayed by any other in-vehicle displays, such as a center stack, and camera images may be from any other interior or exterior vehicle cameras.

The vehicle 100 may also include various “zones” such as a driver zone 101, passenger zones 102, 103, 104, and a cargo zone 105. Additionally, each zone 101-105 may include a camera associated with the zone. For example, the driver zone 101 includes a camera 111, the passenger zone 102 includes a camera 112, the passenger zone 103 includes a camera 113, the passenger zone 104 includes a camera 114, and the cargo zone 105 includes a camera 115. In some examples, fewer or more cameras may be implemented. For example, a zone may share a camera with another zone, or a zone may include multiple cameras. In yet other examples, other zones may be added, such as a trailer zone.

The cameras 111-115 capture images of the zones (i.e., zone images), and the zone images can be displayed on the display 210 as live images, still images, or some combination thereof. In particular, the processing system 200 overlays zone images onto the primary image on the display 210. Each of the zone image overlays is associated with a particular zone (i.e., the zones 101-105) of the vehicle 100. For example, a zone may be internal to the vehicle (e.g., a driver zone, a passenger zone, a cargo zone, etc.) or external to the vehicle (e.g., a trailer zone, an external cargo zone, a roof of the vehicle, etc.). Accordingly, a user (e.g., the driver) is presented with the primary image on the display 210, which is overlaid with the zone image overlays.

The processing system 200 may be used to facilitate a number of use cases for triggering control of a zone by touching a zone image overlay on the display 210. In one such example, if a child is in the back seat (e.g., passenger zone 103) watching a video program on a rear seat entertainment system and does not hear the driver (e.g., a user in the driver zone 101) asking the child a question, the driver may utilize the system 200 to enable the driver to pause the video and/or mute the audio of the rear seat entertainment system that the child is using. This may enable the driver to interact with the child in the passenger zone 103 without disturbing any other passengers.

In another example, a rear-facing infant located in the passenger zone 104 kicks off his blanket. In this case, the driver may use the processing system 200 to raise the temperature for the passenger zone 104 in which the infant is located. In yet another example, the driver may use the processing system 200 to turn a light on in the passenger zone 102 to provide light to a passenger located in the zone who is searching for an object (e.g., looking for glasses in a purse).

In yet another example, a driver may use the processing system 200 to monitor the inside of a trailer attached to the vehicle 100. For example, if the trailer contains livestock, the processing system 200 enables the driver to monitor and control the temperature of the trailer.

The driver may also be able to check the cargo zone 105 to see if all cargo is packed. For example, if the driver wants to see if a particular item is in the cargo zone 105, the driver may use the processing system 200 to pan, tilt, and/or zoom the camera 115 in the cargo zone 105 for a better view of the cargo zone 105.

In another example, the driver may use the processing system to video conference with another car (such as in a convoy) using the display 210. This enables occupant(s) in the vehicle 100 to communicate with the occupant(s) in another vehicle.

In some embodiments, the processing system 200 may be disabled while the vehicle 100 is in a drive mode. This may prevent the driver from triggering control of a zone while the vehicle is in motion. However, in some examples, the processing system 200 may be active even when the vehicle 100 is in drive mode.

FIG. 2 illustrates a block diagram of the processing system 200 of FIG. 1 that includes a zone image overlay module 202, a control module 204, and a display 210 according to embodiments of the present disclosure.

In one example, the processing system 200 displays a primary image (e.g., the primary image 312) on the display 210. Further, the zone image overlay module 202 of the processing system 200 overlays a zone image as the zone image overlay onto the primary image on the in-vehicle display. The zone image is received, for example, from a camera in the zone (e.g., the camera 102 for the zone 112, the camera 105 for the zone 115, etc.).

When a user selects the zone image overlay, such as using a touch input on the display 210, a control interface is presented on the display 210 by the control module 204. The control module 204 may access a zone reference database (not shown) to determine which control interface to display for each particular zone. For example, each zone may have its own control interface based on the controls available for that zone. The user may then select a selectable option (e.g., temperature control, volume control, seat adjustment, light control, window control, video control, etc.) on the display 210 by using the touch input, and the control module 204 causes the adjustment to occur by sending a signal to the appropriate sub-system in the vehicle. For example, if the user selects muting the volume for a particular passenger zone, the control module 204 sends a signal to the audio sub-system of the vehicle to cause the volume to be muted in the particular zone. In other examples, the user may use voice prompts or other auditory signals to provide input to the control interface.

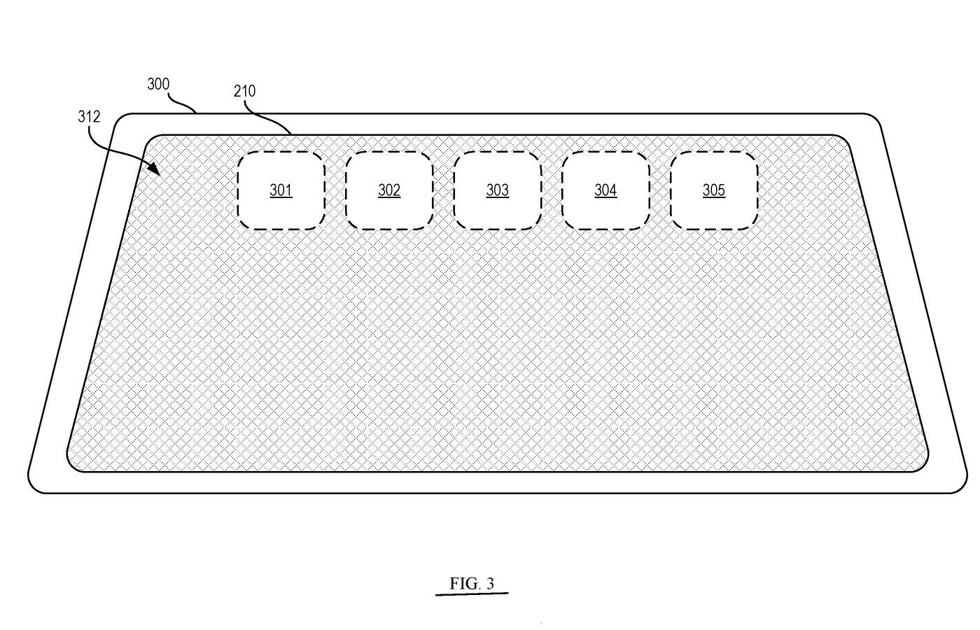

FIG. 3 illustrates an example of an FDM 300 that includes a display 210 for displaying a primary image 312 and a plurality of zone image overlays 301, 302, 303, 304, 305 according to embodiments of the present disclosure. The zone image overlays 301-305 may correspond to the zones 101-105 of FIG. 1 (i.e., the zone image overlay 301 corresponds to the driver zone 101, the zone image overlay 302 corresponds to the passenger zone 102, etc.). The display 210 displays a primary image 312, which may be, for example, an image captured by a camera such as the camera 120 of the vehicle 100 of FIG. 1. In the example of FIG. 3, the primary image 312 is illustrated with cross hatching.

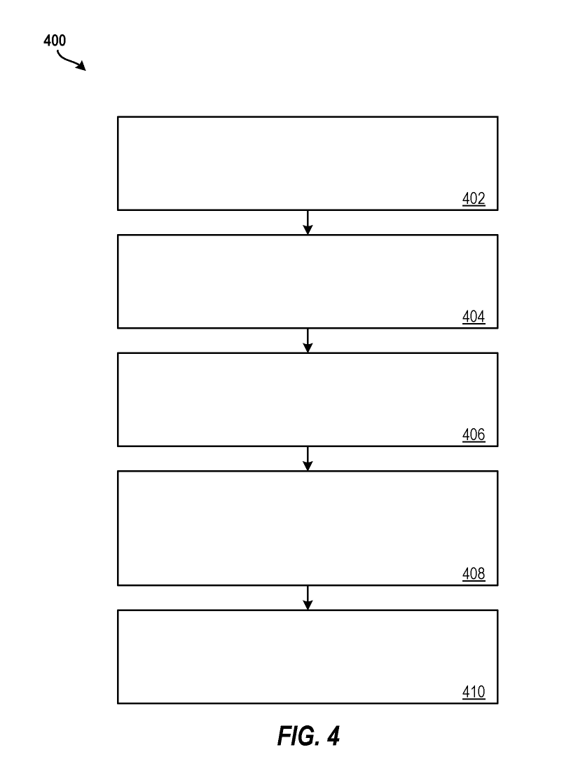

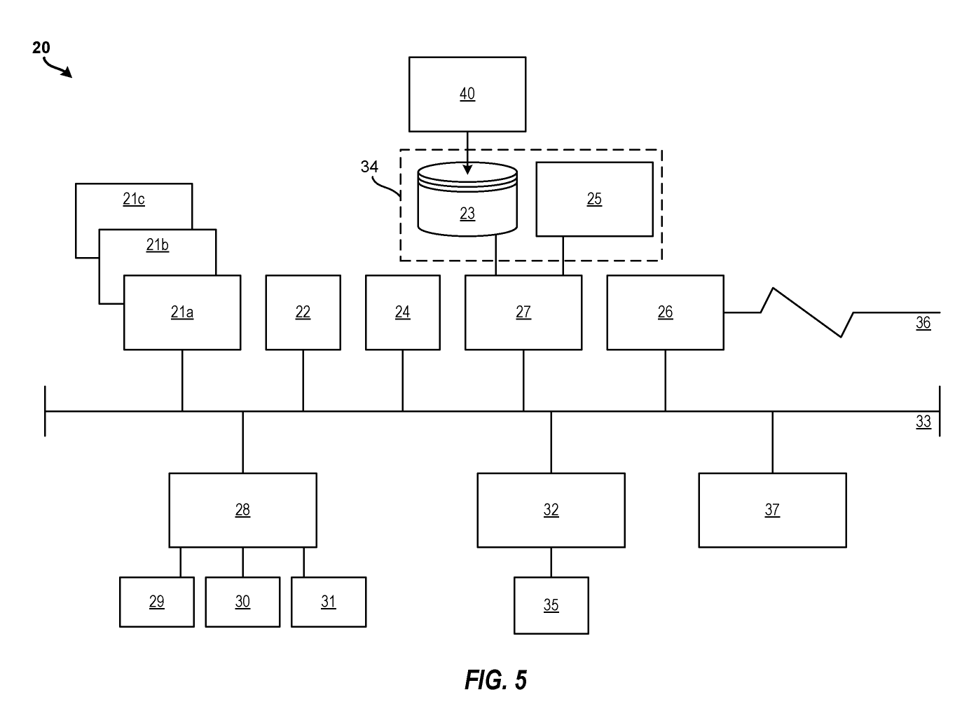

FIG. 4 illustrates a flow diagram of a method for triggering control of a zone of a vehicle using a zone image overlay on an in-vehicle display according to aspects of the present disclosure. The method 400 may be implemented, for example, by the processing system 200, by the processing system 20 of FIG. 5, or by another suitable processing system or device.

At block 402, the method 400 includes displaying, by a processing device (e.g., the processing device 200), a primary image (e.g., the primary image 312) on the in-vehicle display (e.g., the display 210). At block 404, the method 400 includes overlaying, by the processing device, a zone image as the zone image overlay (e.g., one of the zone image overlays 301-305) onto the primary image on the in-vehicle display. The zone image overlay is associated with the zone in the vehicle. At block 406, the method 400 includes receiving, by the processing device, a selection of the zone image overlay.

At block 408, the method 400 includes displaying, by the processing device, a control interface on the in-vehicle display responsive to receiving the selected zone image overlay. The control interface includes a selectable option for controlling an aspect of the zone. For example, the aspect of the zone may be temperature, volume, light, seat adjustments, and the like. In one such example, the user may be presented with a control interface on the in-vehicle display for adjusting the temperature of a zone when the user selects that zone's zone image overlay. The user may then provide an input to adjust the temperature (e.g., increase or decrease the temperature, turn the air conditioning on/off, enable heated seats, etc.).

At block 410, the method 400 includes adjusting, by the processing device, the aspect of the zone based on the selection responsive to receiving a selection of the selectable option for controlling the aspect of the zone. That is, when the user supplies an input to adjust an aspect of the zone, the method 400 includes making the adjustment to the aspect of the zone based on the user's input.

Additional processes also may be included, and it should be understood that the processes depicted in FIG. 4 represent illustrations, and that other processes may be added or existing processes may be removed, modified, or rearranged without departing from the scope and spirit of the present disclosure.

It is understood in advance that the present disclosure is capable of being implemented in conjunction with any other type of computing environment now known or later developed. For example, FIG. 5 illustrates a block diagram of a processing system 20 for implementing the techniques described herein. In examples, processing system 20 has one or more central processing units (processors) 21a, 21b, 21c, etc. (collectively or generically referred to as processor(s) 21 and/or as processing device(s)). In aspects of the present disclosure, each processor 21 may include a reduced instruction set computer (RISC) microprocessor. Processors 21 are coupled to system memory (e.g., random access memory (RAM) 24) and various other components via a system bus 33. Read only memory (ROM) 22 is coupled to system bus 33 and may include a basic input/output system (BIOS), which controls certain basic functions of processing system 20.

Further illustrated are an input/output (I/O) adapter 27 and a communications adapter 24 coupled to system bus 33. I/O adapter 27 may be a small computer system interface (SCSI) adapter that communicates with a hard disk 23 and/or a tape storage drive 25 or any other similar component. I/O adapter 27, hard disk 23, and tape storage device 25 are collectively referred to herein as mass storage 34. Operating system 40 for execution on processing system 20 may be stored in mass storage 34. A network adapter 24 interconnects system bus 33 with an outside network 34 enabling processing system 20 to communicate with other such systems.

A display (e.g., a display monitor) 35 is connected to system bus 33 by display adaptor 32, which may include a graphics adapter to improve the performance of graphics intensive applications and a video controller. In one aspect of the present disclosure, adapters 24, 27, and/or 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 may be interconnected to system bus 33 via user interface adapter 28, which may include, for example, a Super I/O chip integrating multiple device adapters into a single integrated circuit.

In some aspects of the present disclosure, processing system 20 includes a graphics processing unit 37. Graphics processing unit 37 is a specialized electronic circuit designed to manipulate and alter memory to accelerate the creation of images in a frame buffer intended for output to a display. In general, graphics processing unit 37 is very efficient at manipulating computer graphics and image processing, and has a highly parallel structure that makes it more effective than general-purpose CPUs for algorithms where processing of large blocks of data is done in parallel.

Thus, as configured herein, processing system 20 includes processing capability in the form of processors 21, storage capability including system memory (e.g., RAM 24), and mass storage 34, input means such as keyboard 29 and mouse 30, and output capability including speaker 31 and display 35. In some aspects of the present disclosure, a portion of system memory (e.g., RAM 24) and mass storage 34 collectively store an operating system to coordinate the functions of the various components shown in processing system 20.

The present techniques may be implemented as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to aspects of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various examples of the present disclosure have been presented for purposes of illustration, but are not intended to be exhaustive or limited to the embodiments disclosed. Many modifications and variations will be apparent to those of ordinary skill in the art without departing from the scope and spirit of the described techniques. The terminology used herein was chosen to best explain the principles of the present techniques, the practical application or technical improvement over technologies found in the marketplace, or to enable others of ordinary skill in the art to understand the techniques disclosed herein.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present techniques not be limited to the particular embodiments disclosed, but will include all embodiments falling within the scope of the application.

What is claimed is:

1. A computer-implemented method for triggering control of a zone of a vehicle using a zone image overlay on an in-vehicle display, the method comprising:
displaying, by a processing device, a primary image on the in-vehicle display;
overlaying, by the processing device, a zone image as the zone image overlay onto the primary image on the in-vehicle display, wherein the zone image overlay is associated with the zone in the vehicle;
receiving, by the processing device, a selection of the zone image overlay;
responsive to receiving the selected zone image overlay, displaying, by the processing device, a control interface on the in-vehicle display, wherein the control interface comprises a selectable option for controlling an aspect of the zone; and
responsive to receiving a selection of the selectable option for controlling the aspect of the zone, adjusting, by the processing device, the aspect of the zone based on the selection.

2. The computer-implemented method of claim 1, further comprising overlaying, by the processing device, additional zone images as additional zone image overlays onto the primary image on the in-vehicle display.

3. The computer-implemented method of claim 2, wherein each of the additional zone image overlays is associated with one of a plurality of additional zones of the vehicle.

4. The computer-implemented method of claim 1, further comprising hiding, by the processing device, the zone image overlay when the vehicle is in a drive mode.

5. The computer-implemented method of claim 1, wherein the zone is a passenger zone.

6. The computer-implemented method of claim 1, wherein the selectable option is selected from the group consisting of a temperature control, a light control, a seat adjustment, a window control, a video control, and an audio control.

7. The computer-implemented method of claim 1, further comprising, subsequent to adjusting the aspect of the zone, displaying, by the processing device, the primary image on the in-vehicle display.

8. A system for controlling a plurality of zones in a vehicle, the system comprising:
a display configured to display a primary image;
a zone image overlay module configured to overlay a plurality of zone images as a plurality of zone image overlays onto the primary image on the display, wherein each of the plurality of zone image overlays is associated with one of a plurality of zones in the vehicle; and
a control module configured to present a selectable option for controlling an aspect of one of the plurality of zones and to adjust the aspect of the one of the plurality of zones.

9. The system of claim 8, further comprising a camera in each of the plurality of zones to capture the zone image for each of the plurality of zones.

10. The system of claim 8, further comprising a camera external to the vehicle to capture the primary image.

11. The system of claim 8, wherein the zone image overlay module is further configured to hide the plurality of zone image overlays when the vehicle is in a drive mode.

12. The system of claim 8, wherein the selectable option is selected from the group consisting of a temperature control, a light control, a seat adjustment, a window control, a video control, and an audio control.

13. The system of claim 8, wherein the plurality of zones comprises at least one of a passenger zone, a trailer zone, and a cargo zone.

14. A computer program product for triggering control of a zone using a zone image overlay on an in-vehicle display, the computer program product comprising:
a computer readable storage medium having program instructions embodied therewith, wherein the computer readable storage medium is not a transitory signal per se, the program instructions executable by a processing device to cause the processing device to perform a method comprising:
displaying, by the processing device, a primary image on the in-vehicle display;
overlaying, by the processing device, a zone image as the zone image overlay onto the primary image on the in-vehicle display, wherein the zone image overlay is associated with the zone in the vehicle;
receiving, by the processing device, a selection of the zone image overlay;
responsive to receiving the selected zone image overlay, displaying, by the processing device, a control interface on the in-vehicle display, wherein the control interface comprises a selectable option for controlling an aspect of the zone; and
responsive to receiving a selection of the selectable option for controlling the aspect of the zone, adjusting, by the processing device, the aspect of the zone based on the selection.

15. The computer program product of claim 14, the method further comprising overlaying, by the processing device, additional zone images as additional zone image overlays onto the primary image on the in-vehicle display.

16. The computer program product of claim 15, wherein each of the additional zone image overlays is associated with one of a plurality of additional zones of the vehicle.

17. The computer program product of claim 14, the method further comprising hiding, by the processing device, the zone image overlay when the vehicle is in a drive mode.

18. The computer program product of claim 14, wherein the zone is a passenger zone.

19. The computer program product of claim 14, wherein the selectable option is selected from the group consisting of a temperature control, a light control, a seat adjustment, a window control, a video control, and an audio control.

20. The computer program product of claim 14, the method further comprising, subsequent to adjusting the aspect of the zone, displaying, by the processing device, the primary image on the in-vehicle display.
